(19) United States
(12) Patent Application Publication
(10) Pub. No.: US 2008/0092332 A1
(43) Pub. Date: Apr. 24, 2008

(54) Door Hinge for Motor Vehicle

(75) Inventors: Jakob Lowen, Gummersbach (DE); Victor Siegert, Reichshof-Eckenhagen (DE)

Correspondence Address: BACHMAN & LAPOINTE, P.C., 900 CHAPEL STREET, SUITE 1201, NEW HAVEN, CT, 06510, US

(73) Assignee: Automotive Group ISE Innomotive Systems Europe GmbH, Bergneustadt (DE)

(21) Appl. No.: 11/877,963

(22) Filed: Oct. 24, 2007

(30) Foreign Application Priority Data
Oct. 24, 2006 (DE) 10 2006 050 662 6

(51) Int. Cl. E05D 3/02

(52) U.S. Cl. 16/221

(57) ABSTRACT

The invention relates to a door hinge for a motor vehicle with a column console that can be arranged on a column of a door frame, a door console that can be attached to a motor vehicle door assigned to the door frame, wherein the door console and the column console are pin-jointed together via a hinge pin. In order to provide a motor vehicle door hinge that can be produced easily and cost-effectively, it is provided that the door and/or column console is formed by two spaced partial units, wherein the spacing of the partial units of the door and/or the column console is determined by means of a distance element.

### BACKGROUND OF THE INVENTION

The invention relates to a door hinge for a motor vehicle with

a column console that can be arranged on a column of a door frame,

a door console that can be attached to a motor vehicle door assigned to the door frame,

the door console and the column console being pin-jointed together via a hinge pin.

Motor vehicle door hinges of the initially mentioned type are already known in various embodiments. The main job of the motor vehicle door hinges is to thereby ensure a reliable linkage of a door, flap or a top of a motor vehicle to a vehicle body. A generic motor vehicle door hinge is e.g. known from DE 10 2004 012 006 B3.

The fact that different motor vehicle door hinges are required for each of the different vehicle types has a disadvantageous affect on the production costs of the motor vehicle door hinge, since in each case different constructive framework conditions are to be taken into consideration, which requires the development of individually adapted door hinges. It is also disadvantageous that, even in the case of a specific vehicle, the type of motor vehicle door hinge to be used already depends on whether it is used for a left or right vehicle side or front or rear door.

### SUMMARY OF THE INVENTION

The object of the invention is to provide a motor vehicle door hinge, which can be manufactured easily and cost-effectively.

The object is solved through a motor vehicle door hinge with a column console that can be arranged on a column of a door frame, a door console that can be attached to a motor vehicle door assigned to the door frame, wherein the door console and the column console are pin-jointed together via a hinge pin, characterized in that the door and/or column console is formed by two spaced partial units, wherein the spacing of the partial units of the door and/or the column console is determined by means of a distance element. Advantageous further embodiments of the invention are specified herein.

It is characteristic for the motor vehicle door hinge according to the invention that the door and/or column console is formed by two spaced partial units, wherein the spacing of the partial units of the door and/or column console is determined by means of a distance element.

It is important for the motor vehicle door hinge according to the invention that the door and/or column console is formed from two easily manufactured partial units, which are connected together by a distance element for the formation of the respective hinge parts in a manner that is easy from a manufacturing point of view. Even if the motor vehicle door hinge according to the invention has more individual parts than the known motor vehicle door hinges, then it is easier and more cost-effective to produce, since the partial units have a shape that is considerably easier to produce than is the case with one-piece door and column consoles.

The use of a distance element for the connection of the partial units for the production of a door or column console with two spaced partial units is decisive for the low production costs of the motor vehicle door hinge according to the invention. Namely, the distance element determining the spacing makes it possible to produce the door or column console in a simple manner in that they are e.g. attached on opposite ends of the distance element.

Compared to the conventional motor vehicle door hinges, the advantages of the motor vehicle door hinge according to the invention are already achieved when only one of the hinge parts, i.e. the door or column console, is formed from two spaced partial units. However, it is particularly advantageous if both hinge parts are formed from two partial units, wherein the spacing between the partial units of the one is determined by the door or column console by means of the distance element and the spacing of the partial units of the other is determined by the door and column console by means of the hinge pin.

In accordance with this embodiment of the invention, one of the hinge parts is formed by two partial units, the spacing between which is determined by the distance element. On the other hand, the other hinge part is formed by two partial units, the spacing between which is determined by the hinge pin. The use of the hinge pin for the formation of a hinge part has the advantage that, in addition to the distance element, an additional component for determining the spacing between the partial units of the door or column console is not needed when both hinge parts are formed from two partial units. It is particularly advantageous thereby that, in the case of a corresponding embodiment of the partial units, the adjustment of the hinge pin may not be required. Should an adjustment be required nonetheless, then it is generally extremely small and has no affect on the low production costs.

The spacing of the partial units of the motor vehicle door hinge according to the invention is determined by the distance element and, according to a further embodiment of the invention, also by the hinge pin. Further immobilization of the partial units relative to each other, i.e. their radial alignment with each other, can generally take place in any manner. In accordance with a particularly advantageous embodiment of the invention, the distance element and/or the hinge pin are however designed and connected with the partial units of the door and/or column console such that they are also immobilized relative to each other.

This embodiment of the invention makes it possible to omit additional components, whereby the production costs can be further reduced. In accordance with this embodiment of the invention, the partial units of the hinge parts are thus not only determined in their spacing between each other, but are e.g. also secured together against radial rotation.

The embodiment of the distance element and/or the hinge pin or the partial units of the door or column console can thereby generally take place in any manner. However, in accordance with a particularly advantageous embodiment of the invention, the partial units of the door and/or column console have intake openings and the distance element and/or hinge pin have connection sections adjusted for the intake openings. Accordingly, the hinge parts can be produced in a particularly easy manner, namely by mounting the intake openings of the partial units onto the distance element or the hinge pin. The necessity of auxiliary tools or special devices for installing the motor vehicle door hinge is excluded in a particularly reliable manner by this further embodiment.

The embodiment of the distance element for the motor vehicle door hinge according to the invention is generally freely selectable. However, it is particularly advantageous if it is formed by a distance bolt, which has adjusted, tapered connection sections on both ends of intake openings of the partial units. The use of a distance bolt as the distance element is characterized in that it can be produced in a particularly easy manner. The design of tapered connection sections on the ends of the distance bolt can also be produced in a particularly easy manner so that the production costs are further reduced.

As with the distance bolt, the hinge pin also has connection sections on both ends in accordance with a particularly advantageous embodiment of the invention that serve to incorporate the partial units of the door and column console. Since, in some circumstances, conventional hinge pins may already have tapered sections that can be used as connection sections, an adjustment of the hinge pin can be omitted in the case of a corresponding embodiment of the intake opening of the partial units so that the production costs can be further reduced.

The connection sections of the distance bolt or the hinge pin can generally have any shape. For the radial immobilization of the partial units with respect to each other or for the torque-proof arrangement of the partial units on the distance bolt and if necessary the hinge pin, the connection section has a cross-section deviating from the circular form, preferably polygonal, even more preferably hexagonal, in accordance with a particularly advantageous embodiment of the invention.

A connection section provided with a knurl in accordance with this further embodiment, which also ensures a radial immobilization of the hinge parts with respect to each other via the corresponding embodiment of the connection sections, also has a cross-section deviating from a circular form. However, a polygonal, even more preferably hexagonal, embodiment of the connection sections permits a particularly simple radial arrangement of the partial units with respect to each other. Normally, the opposite-lying connection sections on the hinge pin or the distance bolt are arranged symmetrically with respect to each other, which leads to a symmetrical arrangement of the partial units with respect to each other so that the motor vehicle door hinge, e.g. when turned over, can be used at another location on the motor vehicle for the linkage of another door.

However, if applicable, a non-symmetrical, polygonal embodiment of the connection sections is also conceivable, if a radially displaced arrangement of the partial units is required due to the constructive framework conditions. The same could also be achieved through partial units that have a different orientation of the polygonal embodiment of the intake openings. However, this would result in the fact that the two partial units of the door and/or column console would be different. In accordance with an advantageous embodiment of the invention, the partial units of the door and/or column console are however identical, at least symmetrically or mirror images of each other so that the production costs can be further reduced based on the decrease in the various components.

It is particularly advantageous if the partial units are made of sheet metal, preferably sheet metal angles. Their production sequence can already be arranged so that the cuttings are reduced to a minimum. This results in a further reduction in production costs of the motor vehicle door hinge.

The motor vehicle door hinge according to the invention can be used in many different ways. Particularly advantageously, it can be combined with locking units, wherein, according to an advantageous further embodiment of the invention, the locking unit is arranged in a torque-proof manner on the motor vehicle door hinge in a particularly simple manner via a connection element that is arranged on one end on the distance element and on the other end on a locking bushing.

A known locking unit concerns for example a locking unit in which spring-loaded locking elements are moved when a vehicle door is moved with respect to an immobilized locking bushing, wherein the interior surface of the locking bushing has locking recesses for the immobilization of different opening angles. The use of a distance element according to the invention thereby makes it possible to immobilize the locking bushing in a particularly simply manner with respect to the locking elements. The support thereby takes place solely via the connection element so that further immobilization of the locking bushing can be omitted.

As a general rule, any designs are conceivable for the restriction of the pivoting of the locking hinge, i.e. for the immobilization of the maximum opening angle and, if necessary, the closed setting. However, according to a particularly advantageous embodiment of the invention, at least one free end of the distance bolt projects out of the partial units of the one from the door console or column console and forms a stop for at least one partial unit of the other from the door console or the column console. Thus, the pivot angle, preferably the maximum open angle, can be immobilized in a particularly simple manner without the necessity of additional components. It is thereby particularly preferred that the two free ends of the distance bolt project from the partial units of the door or column console and form stops for the partial units of the other from the door or column console. In accordance with this further embodiment of the invention, the functional reliability of the motor vehicle door hinge is further increased, whereby it is in particular prevented that the motor vehicle door hinge rotates on itself, since the partial units of the door or column console are in simultaneous contact with the free ends.

In order to increase the ease of use and in order to increase the lifespan of the motor vehicle door hinge, the partial units that can be engaged with the free ends of the distance bolt are formed in the contact area with the free ends of the distance bolt in accordance with the free ends. This ensures a planar stop and prevents wear and tear in a particularly advantageous manner. In particular, this ensures that the opening angle determined by the stop remains the same over the entire lifespan of the motor vehicle door hinge.

Further improvement in the functionality is achieved in that the free ends of the distance bolt have a cross-section deviating from the cross-sectional form of the connection section, which is preferably round, and the contact area of the partial units has a correspondingly round design.

### BRIEF DESCRIPTION OF THE DRAWINGS

Exemplary embodiments of the invention are explained in greater detail below with reference to the drawings.

FIG. 1 shows a perspective view of a first embodiment of a motor vehicle door hinge;

FIG. 2 shows a perspective view of a second embodiment of a motor vehicle door hinge with a locking unit;

FIG. 3 shows a side view of the motor vehicle door hinge from FIG. 1;

FIG. 4 shows a side view of the motor vehicle door hinge from FIG. 2;

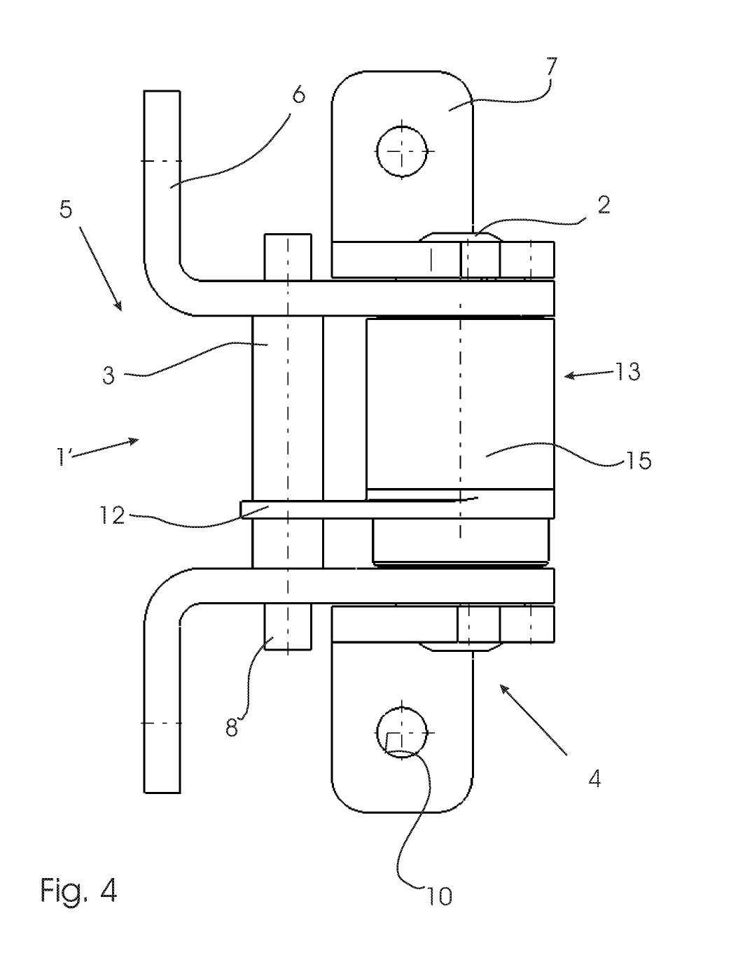

FIG. 5 shows a top view of the motor vehicle door hinge from FIG. 2 in a closed position;

FIG. 6 shows a top view of the motor vehicle door hinge from FIG. 2 in an open position and

FIG. 7 shows a view of a cut through the motor vehicle door hinge from FIG. 2.

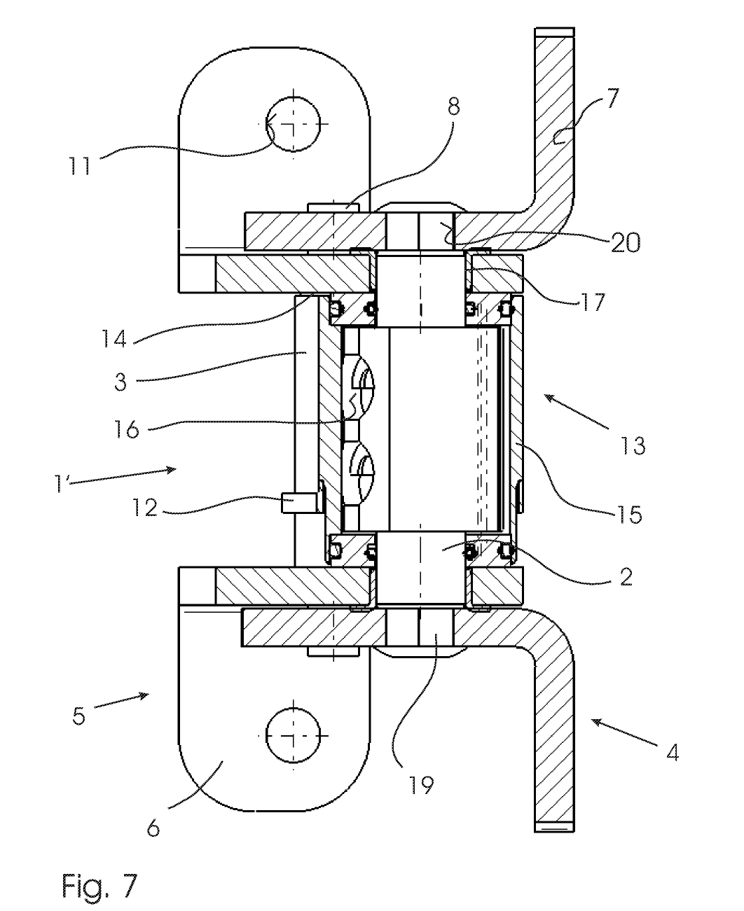

### DETAILED DESCRIPTION OF THE DRAWINGS

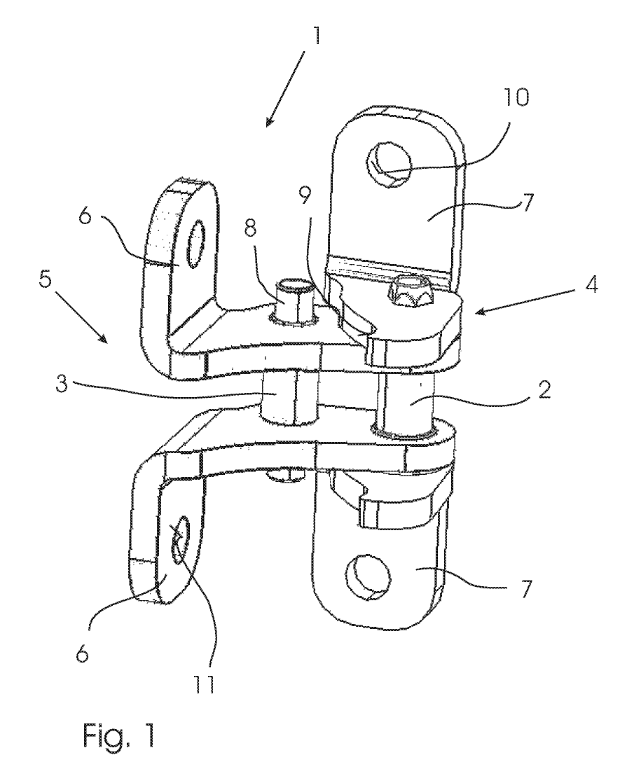

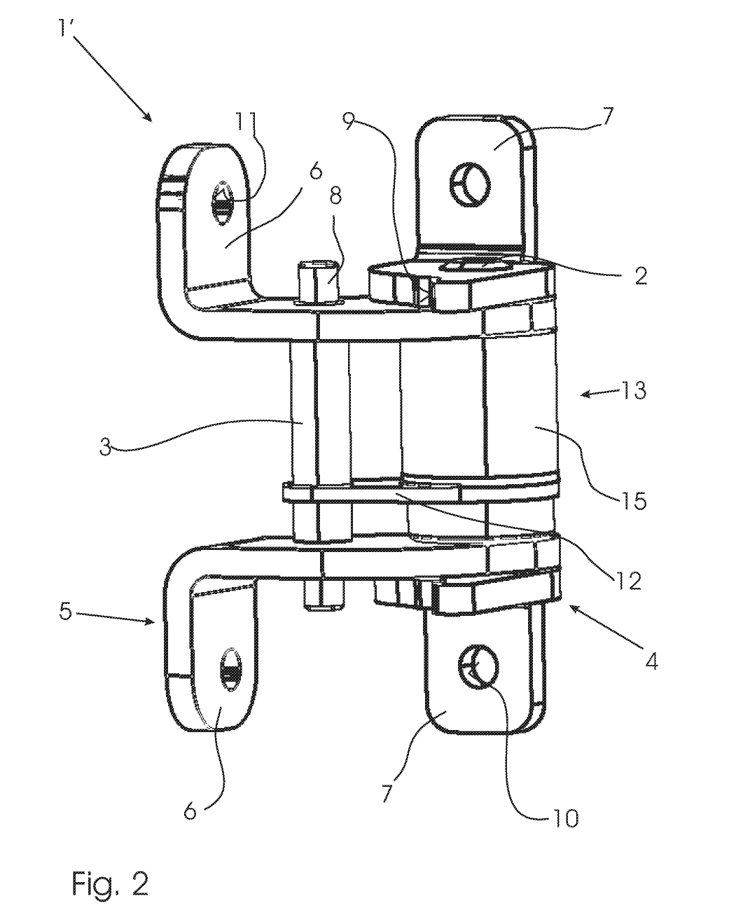

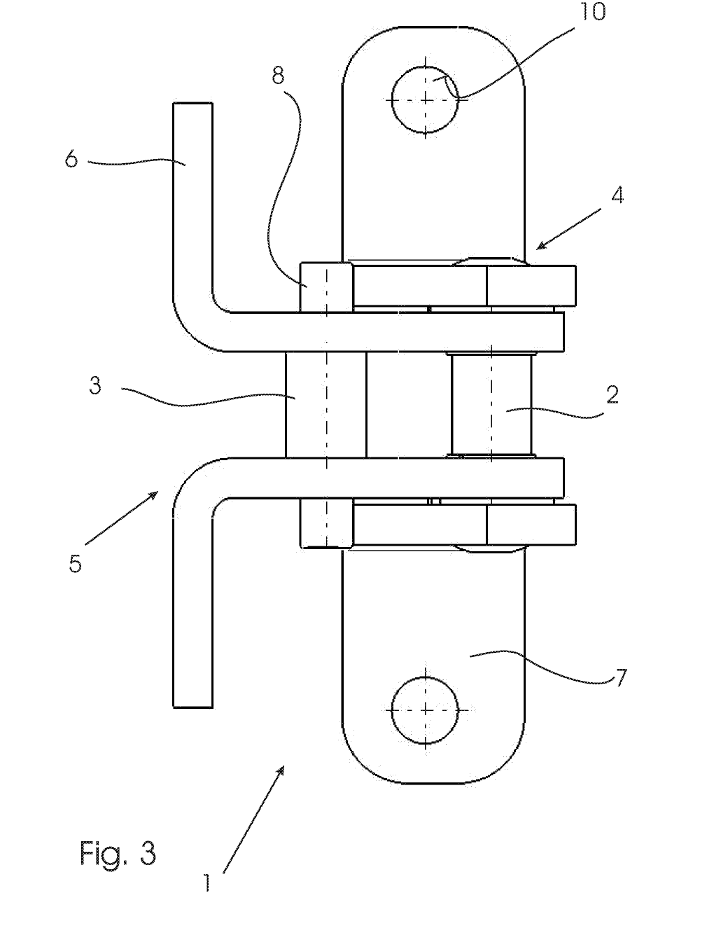

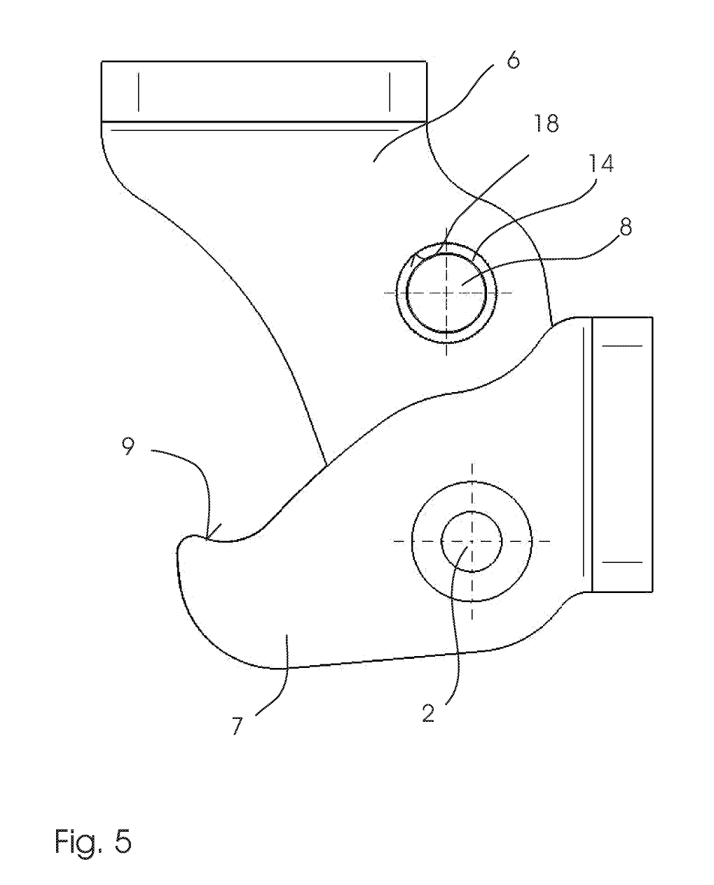

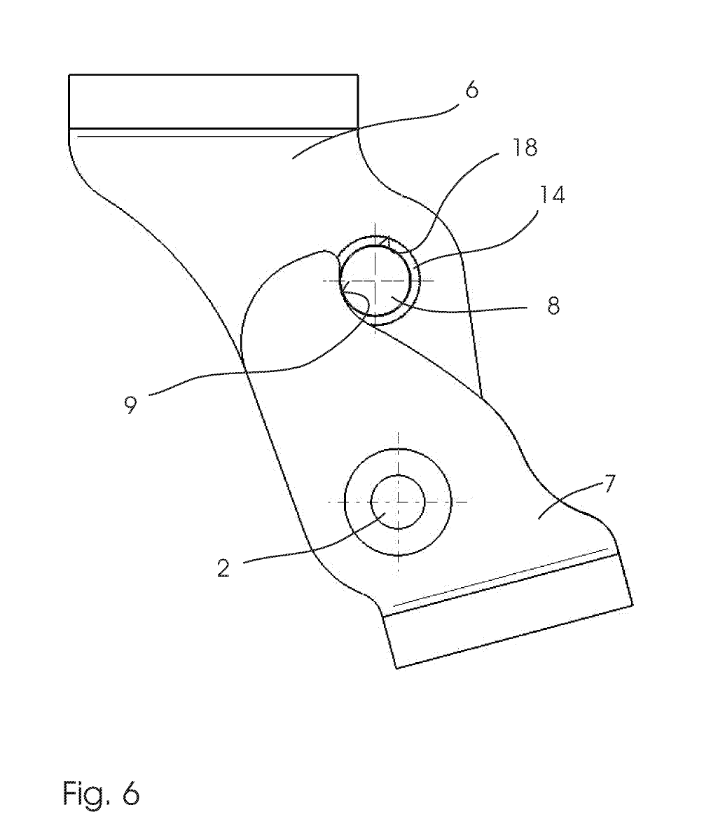

In the first exemplary embodiment of a motor vehicle door hinge 1 shown in FIGS. 1 and 3, both a column console 5 and a door console 4 are formed by two symmetrically formed sheet metal angles 6, 7. The sheet metal angles 6 of the column console 5 are connected together by means of a distance element designed as a distance bolt 3. For this, connection sections 14 arranged in the area of the ends of the distance bolt 3 are arranged in corresponding intake openings 18 of the sheet metal angles 6 (see FIGS. 5 and 6; the sheet metal angles 6 and the distance bolt 3 in the embodiment of the motor vehicle door hinge 1 shown in FIG. 1 match the embodiment shown in FIG. 2).

For the arrangement of the column console 5 on a door frame (not shown), the sheet metal angles 6 have openings 11 for incorporating retaining bolts.

The door console 4 is also formed by two sheet metal angles 7, which are connected together via a hinge pin 2. The hinge pin 2 is thereby pivot-mounted in two opposite-lying further openings of the sheet metal angles 6 using two bracket bushings 17.

Free ends 8 of the distance bolt 3 projecting out of the sheet metal angles 6 serve as a stop for the sheet metal angles 7, which have an arched design in the contact area 9 with the free ends 8 according to the free ends 8 (see FIGS. 5 and 6).

The symmetrical design of the motor vehicle door hinge 1 makes it possible when turned over to use both sides of a vehicle (not shown) for the linkage of a door (also not shown).

In the second exemplary embodiment of a motor vehicle door hinge 1′ shown in FIG. 2, the structure mainly matches the structure of the previously shown motor vehicle door hinge 1. The motor vehicle door hinge 1′ differs in the arrangement of a locking unit 13, which extends around the hinge pin 2 between the sheet metal angles 6 of the column console 5.

The locking unit 13 has locking elements (not shown) arranged in openings 16 of the hinge pin 2, which glide along on the interior of a locking bushing 15. For the immobilization of certain opening positions of the motor vehicle door hinge 1′, the locking bushing 15 has locking recesses (not shown) on its interior, into which the locking elements can engage.

For the functional reliability of the locking unit 13, it is required that the locking bushing 15 is immobilized relative to the hinge pin 2. For this, the motor vehicle door hinge 1′ has a connection element 12, which is connected on one end with the distance element 3 and on the other end with the locking bushing 15 and immobilizes it with respect to the hinge pin 2. For the torque-proof connection of the sheet metal angles 7 of the door console 4, the sheet metal angles 7 have formed hexagonal intake openings 20 according to the connection sections 19 of the hinge pin 2. Bracket bushings 17 arranged in the sheet metal angles 6 of the column console 5 serve to incorporate in a rotatable manner the hinge pin 2 on the column console 5.

1. Motor vehicle door hinge with
a column console that can be arranged on a column of a door frame,
a door console that can be attached to a motor vehicle door assigned to the door frame, wherein
the door console and the column console are pin-jointed together via a hinge pin,
characterized in that
the door and/or column console (4, 5) is formed by two spaced partial units (6, 7), wherein the spacing of the partial units (6, 7) of the door and/or the column console (4, 5) is determined by means of a distance element (3).

2. Motor vehicle door hinge according to claim 1, characterized in that the spacing of the partial units (6, 7) of the one is determined from the door or column console (4, 5) by means of the distance element (3) and the distance of the partial units (6, 7) of the other is determined from the door or column console (4, 5) by means of the hinge pin (2).

3. Motor vehicle door hinge according to claim 1, characterized in that the distance element (3) and/or the hinge pin (2) is designed and connected with the partial units (6, 7) of the door and/or column console such that these are immobilized relative to each other.

4. Motor vehicle door hinge according to claim 1, characterized in that the partial units (6, 7) of the door and/or column console (4, 5) have intake openings (18, 20) and the distance element (3) and/or the hinge pin (2) have connection sections (14, 19) that are adjusted for the intake openings (18, 20).

5. Motor vehicle door hinge according to claim 1, characterized in that the distance element is formed by a distance bolt (3), which has adjusted, tapered connection sections (14) on both ends of the intake openings (18).

6. Motor vehicle door hinge according to claim 1, characterized in that the hinge pin (2) has connection sections (19) tapered on both ends for the incorporation of the partial units (6, 7) of the door or column console (4, 5).

7. Motor vehicle door hinge according to claim 4, characterized in that the connection section (14, 19) has a cross-section deviating from the circular form.

8. Motor vehicle door hinge according to claim 1, characterized in that at least one free end (8) of the distance bolt (3) projects out of one partial unit (6, 7) of the door and/or column console (4, 5).

9. Motor vehicle door hinge according to claim 1, characterized in that the partial units (6, 7) of the door and/or column console (4, 5) are both symmetrical or mirror images of each other.

10. Motor vehicle door hinge according to claim 1, characterized in that the partial units (6, 7) are made of sheet metal.

11. Motor vehicle door hinge according to claim 1, characterized in that a locking unit (13) is connected in a torque-proof manner on the door or column console (4, 5) of the motor vehicle door hinge (1) via a connection element (12) arranged on one end on the distance element (3) and on the other end on a locking bushing (15).

12. Motor vehicle door hinge according to claim 1, characterized in that at least one free end (8) of the distance bolt (3) projects out of the partial units (6, 7) of the one from the door console (4) or column console (5) and forms a stop for at least one partial unit (6, 7) of the other from the door console (4) or the column console (5).

13. Motor vehicle door hinge according to claim 1, characterized in that the two free ends (8) of the distance bolt (3) form stops for the partial units (6, 7) of the door and/or column console (4, 5).

14. Motor vehicle door hinge according to claim 1, characterized in that the partial units (6, 7), which can be engaged with the free ends (8) of the distance bolt (3), are designed in the contact area (9) in accordance with the free ends (8).

15. Motor vehicle door hinge according to claim 1, characterized in that the partial units (6, 7) of the door console (4) or the column console (5), which can be engaged with the free ends (8) of the distance bolt (3), are arranged such that they are simultaneously engaged with the free ends (8).

16. Motor vehicle door hinge according to claim 1, characterized in that the free ends (8) of the distance bolt (3) have a round cross-section deviating from the cross-sectional shape of the connection section (14).

17. Motor vehicle door hinge according to claim 1, characterized in that both free ends (8) of the distance bolt (3) projects out of one partial unit (6, 7) of the door and/or column console (4, 5).

18. Motor vehicle door hinge according to claim 1, characterized in that the partial units (6, 7) of the door and/or column console (4, 5) are identical.

19. Motor vehicle door hinge according to claim 4, characterized in that the connection section (14, 19) has a polygonal cross-section.

20. Motor vehicle door hinge according to claim 4, characterized in that the connection section (14, 19) has a hexagonal cross-section.
